(19) United States
(12) Patent Application Publication
(10) Pub. No.: US 2009/0090196 A1
(43) Pub. Date: Apr. 9, 2009

(54) Preconcentrator and Detector Apparatus

(76) Inventors: Alastair Clark, Watford (GB); Henry Paul McIntyre, Watford (GB); William Angus Munro, Watford (GB); Stephen John Taylor, Hyde Heath (GB); Robert Brian Turner, London (GB)

Correspondence Address: FOLEY AND LARDNER LLP;SUITE 500, 3000 K STREET NW, WASHINGTON, DC, 20007, US

(21) Appl. No.: 12/225,482

(22) PCT Filed: Mar. 27, 2007
(86) PCT No.: PCT/GB2007/001098

§ 371 Date: Sep. 23, 2008

(30) Foreign Application Priority Data
Mar. 30, 2006 (GB) 0606346.5

(51) Int. Cl. G01N 1/40; B01D 59/44

(52) U.S. Cl. 73/863.12; 250/288

(57) ABSTRACT

IMS apparatus has a preconcentrator (20) connected at the inlet (2) of an IMS detector (1) such that all gas supplied to the detector flows through the preconcentrator. The preconcentrator comprises a metal tube (21) having a layer of silicone rubber (24) exposed on its inner surface (25). An electrical resistance heating element (22) extends under the silicone rubber layer (24) and is connected to a power source (23) such that the silicone rubber layer can be periodically heated to desorb substances absorbed by the layer and release them to flow to the IMS detector 1 at a higher concentration. The silicone rubber (24) can operate in the desorption phase in the presence of air without degradation.

This invention relates to preconcentrators of the kind arranged to absorb substances from air flowed through the preconcentrator.

It can be very difficult reliably to detect chemicals present in very low concentration in gases and vapours, such as in an ion mobility spectrometer (IMS). To reduce this problem it is known that chemicals in a gas or vapour can be concentrated by passing the gas or vapour through some form of concentrator, which is arranged to absorb or trap the chemical of interest in a manner that enables it to be released later in a batch when sufficient has accumulated to enable reliable detection. Typically, the chemical is released by applying heat or radiation to the concentrator. U.S. Pat. No. 4,698,071 describes a concentrator employing a concentration powder and using heat to release the concentrated chemical. U.S. Pat. No. 5,551,278 uses specialist gas chromatograph materials to absorb explosive vapours in air, which are subsequently desorbed using infra-red radiation and by supplying hydrogen as a carrier gas.

It is an object of the present invention to provide an alternative preconcentrator and method that can be used in air.

According to one aspect of the present invention there is provided a preconcentrator of the above-specified kind, characterised in that the preconcentrator includes a tubular member having a layer of silicone rubber material on an inner surface arranged to absorb substances from air flowed through the tubular member, and a heater for heating the silicone rubber material in the presence of air to desorb the substances for detection.

The layer of silicone rubber is preferably a coating on the inside of the tubular member. The heater preferably includes an electrical resistance heating element on an inside surface of the tubular member under the layer of silicone rubber. The tubular member is preferably of a metal.

According to another aspect of the present invention there is provided detection apparatus including a detection device having an inlet by which gas is supplied to the unit for detection, characterised in that the apparatus includes a preconcentrator according to the above one aspect of the invention connected at the inlet such that gas passes to the detection device via the preconcentrator.

According to a further aspect of the present invention there is provided detection apparatus including a detection device, an inlet by which air to be sampled is admitted to the apparatus, a tube connected in line with the inlet such that air supplied to the detection apparatus flows through the tube to the detection device, characterised in that the tube has an internal surface of a silicone rubber adapted to absorb substances from air flowed through the tube and a heater arranged to heat the silicone rubber periodically to release absorbed substances into the air flowed through the tube in a higher concentration to the detection device.

The detection device may include an ion mobility spectrometer. The detection device is preferably arranged to detect substances in the form of chemical warfare agents. The layer of silicone rubber may be a coating on an inside of the tube. The heater preferably includes an electrical resistance heating element on an inside surface of the tube under the silicone rubber. The tube is preferably of a metal.

According to a fourth aspect of the present invention there is provided a method of detecting low concentrations of substances in air including the steps of flowing the air to a detection device via a tube having an internal surface of silicone rubber such that the substances are absorbed into the surface, and heating the silicone rubber periodically to desorb the substances into the air flowed through the tube such that the concentration of substances is increased to a level sufficient for detection by the detection device.

Detector apparatus including a preconcentrator and a method of detection according to the present invention will now be described, by way of example, with reference to the accompanying drawing, in which:

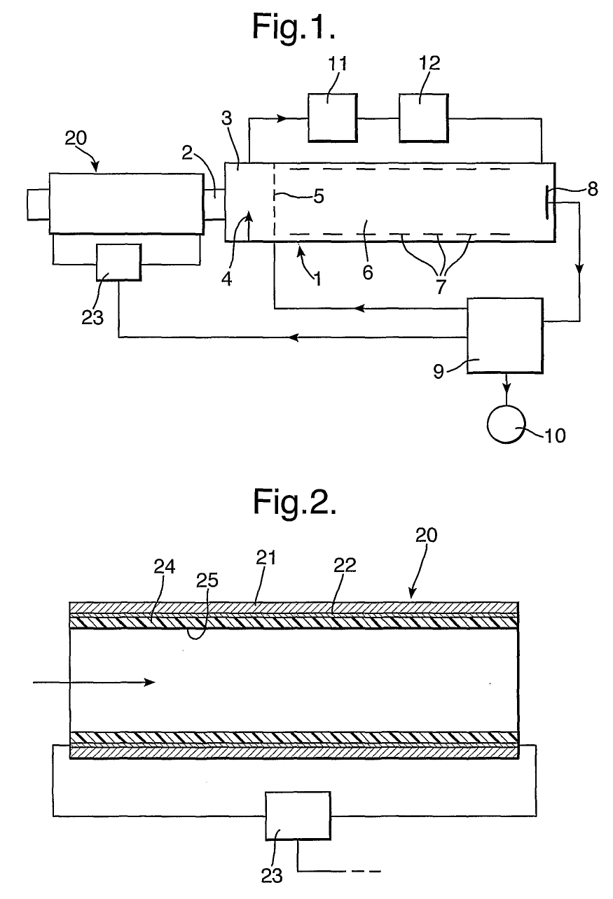

FIG. 1 shows the apparatus schematically; and

FIG. 2 is a cross-sectional side elevation view of the preconcentrator.

The apparatus includes a conventional detector device in the form of an IMS cell 1 having an inlet 2 at one end by which air to be sampled is admitted to the cell. The IMS cell 1 could have a gas chromatograph (not shown) connected in line with the IMS inlet. The cell 1 includes a conventional ionization region 3, such as having a corona discharge point 4 and an electronic shutter or gate 5 at the inlet end of a drift region 6. The drift region 6 has electrodes 7 spaced along its length by which an electric field is applied to draw ions along the region. A collector plate 8 at the far end of the drift region 6 collects ions that pass along that region. A processor 9 detects the change in charge on the plate 8 as ions reach it. The processor 9 also controls opening of the shutter 5 and produces a spectrum of time of flight of the different ions along the drift region 6. The processor 9 is particularly arranged to detect the presence of chemical warfare agents in air and to provide a warning or indication of such agents on an indicator 10. A pump 11 draws air from the inlet 2 and circulates it along the drift region 6 against the direction of flow of ions. The air is dried and cleaned by a molecular sieve pack 12 in the usual way.

The apparatus also includes a preconcentrator 20 connected to the inlet 2 of the IMS cell 1 so that all inlet air must flow through the preconcentrator before reaching the IMS cell. The preconcentrator includes a cylindrical tube 21, such as of a metal, having an electrical resistance heating element 22 supported on its inner surface. The heating element 22 could be of various different forms, such as a thin resistance wire or track, or a thin layer of a resistance material adhered to the inner surface of the tube 21 and extending over substantially its entire area. Opposite ends of the heating element 22 are connected to a power supply 23 by which a voltage can be applied across the element to cause heating. The power supply 23 is switched on and off by control from the processor 9. The preconcentrator 20 also has an inner layer 24 of a silicone rubber material, such as Silastic from Dow Corning, which has dimethyl and methylvinyl siloxane copolymers reinforced with fumed silica. The layer 24 is preferably a relatively thin coating, less than 1 mm and covers the entire inner surface of the tube 21 and heating element 22. The inner surface 25 of the tube 21 exposed to air flow along it is, therefore, provided by the silicone rubber material 24. It is not essential that the silicone rubber surface be provided by a coating since the layer could be provided in other ways, such as, for example by a preformed silicone sleeve inserted into and bonded to the tube. The degree to which air flowing along the tube 21 contacts the silicone rubber surface 25 depends on the nature of the flow through the tube, its diameter and its length. Contact with the silicone rubber surface 25 can be increased by increasing the length of the tube (which need not be straight but could, for example, be coiled for a more compact configuration), reducing its diameter or introducing some form of flow modifier to increase turbulence. Alternatively, the apparatus could have several tubes coupled in parallel with one another in order to increase the effective surface area of the silicone rubber without increasing the resistance to flow.

In operation, all the air supplied to the IMS cell 1 passes through the silicone-coated tube 21. The silicone rubber 24 acts to absorb any chemical warfare agents in the air so that, initially, the IMS cell produces a nil response. Periodically, the processor 9 switches on the power supply 23 to cause the heater 22 in the preconcentrator 20 to heat the silicone rubber lining 24 of the tube 21. This takes place while air continues to flow through the tube 21. The nature of the heating element 22 allows for very rapid heating so that there is a corresponding rapid rise in the temperature of the silicone layer 24. It will be appreciated that the speed of rise of temperature of the inner, exposed surface 25 of the silicone rubber 24 will depend on its thickness so that the speed can be increased by making the layer thin. This, in turn, leads to a rapid desorption of the chemicals absorbed into the silicone rubber layer 24 so that the molecules of these chemicals are rapidly released to the air flow through the tube where they mix with any chemicals in the ambient air. These chemicals, therefore, flow to the IMS cell 1 in a considerably higher concentration than they are present in the ambient air and at a level sufficiently high for the IMS cell to detect reliably.

The processor 9 then turns off the power supply 23. The heater 22 rapidly cools down because of its relatively low bulk and the high thermal conductivity of the tube 21 itself. The low bulk of the silicone rubber layer 24 and the flow of air through the tube 21 help the silicone layer to cool down rapidly so that chemicals in the air are soon reabsorbed by the layer for the next heating and cooling cycle. The processor 9 can be arranged to vary the length of the absorption and desorption parts of the cycle and this could be based on the results of the analysis performed by the IMS cell 1. For example, if no chemicals were detected after an absorption cycle of one period, the processor 9 could be arranged to lengthen this cycle to check whether the reason for the nil response was because the chemical was present but only at a very low level. Preferably the processor 9 would combine a number of relatively short absorption cycles (selected to be sufficient to detect the chemical when present at a hazardous level), and then periodically introduce a relatively long absorption cycle if there were a nil response. In this way, a rapid response can be given when chemicals are present at hazardous levels and also advance notice can be given when chemicals are present at relatively low levels.

The arrangement of the present invention enables high levels of preconcentration to be achieved and without the need for expensive or hazardous materials. The silicone rubber can operate entirely in an air atmosphere without degradation, in contrast with some previous preconcentrators, which have required special gases to flush the preconcentrator during the desorption phase. By using air, this avoids the need to provide canisters of special gas, thereby making the detector apparatus easier to provide in a small, portable form, enabling it to operate for longer periods without the need to replenish disposables and reducing running costs.

The heater used to cause desorption need not be an electrical resistance heating element on the inside of the tube. Instead, other techniques could be used to raise the temperature of the silicone rubber layer, such as, for example, radiation or a source of heated fluid. Active means could be used to cool the tube, such as a fan, heat exchanger, electronic cooling devices or the like.

The present invention is not limited to ion mobility spectrometers but could be used with other detection devices. Supporting the silicone rubber on the wall of the tube itself is particularly advantageous because it enables rapid thermal cycling but the silicone rubber could instead be supported on some other substrate within a heating tube, such as on a mesh.

1. A preconcentrator arranged to absorb substances from air flowed through the preconcentrator, wherein the preconcentrator includes a tubular member having a layer of silicone rubber material on an inner surface arranged to absorb substances from air flowed through the tubular member, and a heater for heating the silicone rubber material in the presence of air to desorb the substances for detection.

2. A preconcentrator according to claim 1, wherein the layer of silicone rubber is a coating on an inside of the tubular member.

3. A preconcentrator according to claim 1, wherein the heater includes an electrical resistance heating element on an inside surface of the tubular member under the layer of silicone rubber.

4. A preconcentrator according to claim 1, wherein the tubular member is of a metal.

5. Detection apparatus including a detection device having an inlet by which gas is supplied to the unit for detection, wherein the apparatus includes a preconcentrator according to claim 1 connected at the inlet such that gas passes to the detection device via the preconcentrator.

6. Detection apparatus including a detection device, an inlet by which air to be sampled is admitted to the apparatus, a tube connected in line with the inlet such that air supplied to the detection apparatus flows through the tube to the detection device, wherein the tube has an internal surface of a silicone rubber adapted to absorb substances from air flowed through the tube and a heater arranged to heat the silicone rubber periodically to release absorbed substances into the air flowed through the tube in a higher concentration to the detection device.

7. Detection apparatus according to claim 5, wherein the detection device includes an ion mobility spectrometer.

8. Detection apparatus according to claim 5, wherein the detection device is arranged to detect substances in the form of chemical warfare agents.

9. Detection apparatus according to claim 6, wherein the layer of silicone rubber is a coating on an inside of the tube.

10. Detection apparatus according to claim 6, wherein the heater includes an electrical resistance heating element on an inside surface of the tube under the silicone rubber.

11. Detection apparatus according to claim 6, wherein the tube is of a metal.

12. A method of detecting low concentrations of substances in air including the steps of flowing the air to a detection device via a tube having an internal surface of silicone rubber such that the substances are absorbed into the surface, and heating the silicone rubber periodically to desorb the substances into the air flowed through the tube such that the concentration of substances is increased to a level sufficient for detection by the detection device.
